(19) United States
(12) Patent Application Publication
(10) Pub. No.: US 2002/0114905 A1
(43) Pub. Date: Aug. 22, 2002

(54) Antiskid member of a cooling mug

(76) Inventor: Chin-Lai Su, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/788,453

(22) Filed: Feb. 21, 2001

(51) Int. Cl. B32B 1/02

(52) U.S. Cl. 428/34.1; 428/34.7

(57) ABSTRACT

An antiskid member of a cooling mug is attached to a bottom side of the cooling mug. The antiskid member can be secured in a circular locating protrusion on the cooling mug bottom side. The antiskid member can also be attached to the bottom side by means of glue or an injection molding machine, which directly forms the antiskid member on the bottom side.

### BACKGROUND OF THE INVENTION

The present invention relates to an antiskid member of a cooling mug which can prevent the cooling mug from sliding easily over a table.

A cooling mug has an inner glass part and an outer glass part forming a hermetically sealed holding room between both; liquids such as water are received in the holding room. The cooling mug is first kept in a freezer for the liquid received in the holding room to freeze. When a user uses the cooling mug to hold drinks such as beer, the drinks can be kept cool for a relatively long time by the frozen liquid in the holding room.

However, much water vapour from the air will gather on the outer glass part and the bottom of the cooling mug because the cooling mug is very cold. Consequently, the cooling mug would slide easily over the table and fall onto the ground because the bottom and the table are very smooth, and because the water vapour makes the table very slippery. And, the drinks in the cooling mug would spill, and even the cooling mug would break.

### SUMMARY OF THE INVENTION

Therefore, it is a main object of the present invention to provide an antiskid member for the cooling mug to prevent the cooling mug from sliding easily over the table.

The antiskid member of the cooling mug can be secured in a circular locating protrusion on a bottom side of the cooling mug.

The antiskid member can also be attached to the bottom side of the cooing mug by means of glue or an injection molding machine, which forms the antiskid member directly on the bottom side.

Because the desirable friction between the antiskid member and the table, the cooling mug can be protected from sliding easily over the table.

### BRIEF DESCRIPTION OF THE DRAWINGS

This invention will be better understood by referring to the accompanying drawings, wherein:

FIG. 1 is an exploded perspective view of a cooling mug with an antiskid member according to a first embodiment of the present invention.

FIG. 2 is a cross-sectional view of the cooling mug in FIG. 1.

FIG. 3 is a cross-sectional view of a cooling mug with an antiskid member according to a second embodiment of the present invention.

### DETAILED DESCRIPTION OF THE PREFERRED EMBODIMENTS

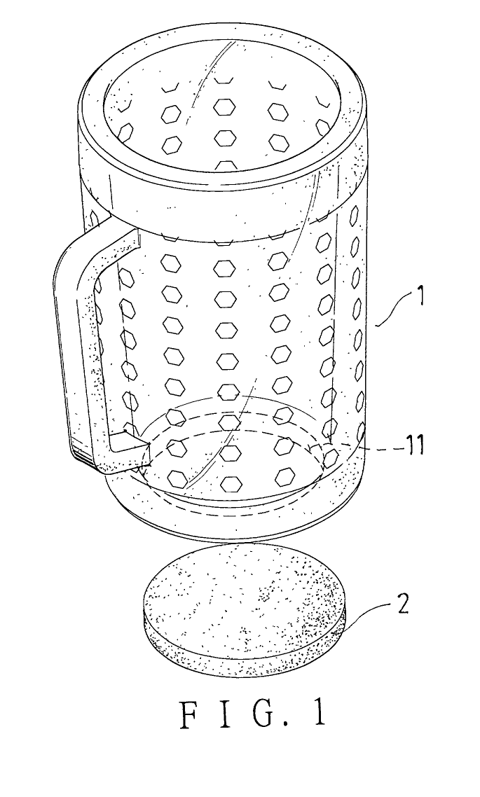

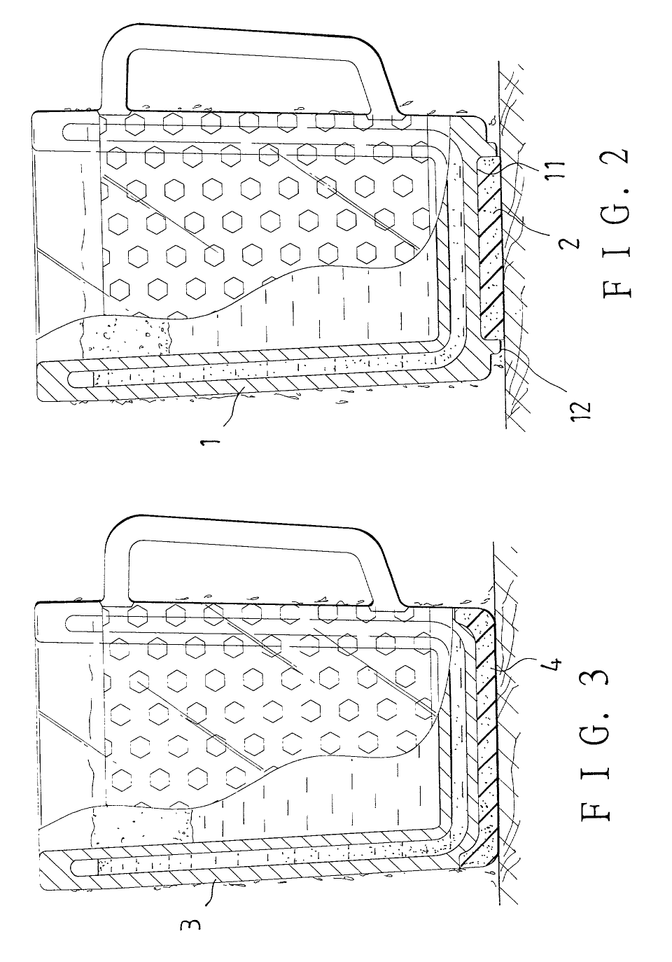

Referring to FIGS. 1 and 2, a cooling mug of the present invention has a circular locating protrusion on a bottom side; the circular locating protrusion forms a receiving room 11 therein, and has a lower end portion 12.

An antiskid member 2 is fitted into the receiving room 11; the circular locating protrusion securers the antiskid member 2 in position. The bottom side of the antiskid member 2 stands out beyond the lower end portion 12 of the circular locating protrusion such that same can touch the table when the cooling mug stands on the table.

The antiskid member 2 can be made of thermoplastic elastomers (TPE).

Referring to FIG. 3, in a second embodiment of the present invention, an antiskid member 4 is attached to a bottom side of a cooling mug 3; the way to attach the antiskid member to the cooling mug 3 can be using glue or directly making the antiskid member 4 on the cooling mug bottom by means of injection moulding.

The antiskid member 4 can also be made of thermoplastic elastomers (TPE).

When the cooling mug 1 and 3 stand on the table, the antiskid members 2 and 4 prevent the cooling mugs 1 and 3 from sliding easily over the table because of a desirable friction between the antiskid members and the table. Thus, the cooling mugs are protected from falling onto the ground when the table become slippery due to water vapour formed on the bottom of the cooling mugs.

What is claimed is:

1. An antiskid member of a cooling mug being secured to a bottom side of said cooling mug, said antiskid member being capable of preventing said cooling mug from sliding easily over a table when said cooling mug stands on said table.

2. The antiskid member of a cooling mug as claimed in claim 1 being secured in a circular locating protrusion on said bottom side of said cooling mug.

3. The antiskid member of a cooling mug as claimed in claim 1 being secured to said bottom by means of glue.

4. The antiskid member of a cooling mug as claimed in claim 1 being securely formed on said bottom by means of injection molding.
